(19) United States
(12) Patent Application Publication
(10) Pub. No.: US 2014/0184094 A1
(43) Pub. Date: Jul. 3, 2014

(54) CONNECTOR POSITION DEVICE

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventors: XIAO-GANG YIN, Shenzhen (CN); GUO-YI CHEN, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 14/011,754

(22) Filed: Aug. 28, 2013

(30) Foreign Application Priority Data
Dec. 28, 2012 (CN) 2012105784745

(51) Int. Cl. H05B 33/08

(52) U.S. Cl. CPC H05B 33/0821
USPC 315/291

(57) ABSTRACT

A connector position device includes a light emitting diode (LED) and a switch. The LED is fixed facing a connector of a motherboard. An anode of the LED is connected to a power supply; a cathode of the LED is connected to a south bridge chip. The switch is connected to the south bridge chip to control the south bridge chip to output a high level signal or a low level signal. When the switch is turned on, the south bridge chip outputs a low level signal to the cathode of the LED and the LED is lit. When the switch is turned off, the south bridge chip outputs a high level signal to the cathode of the LED and the LED is turned off.

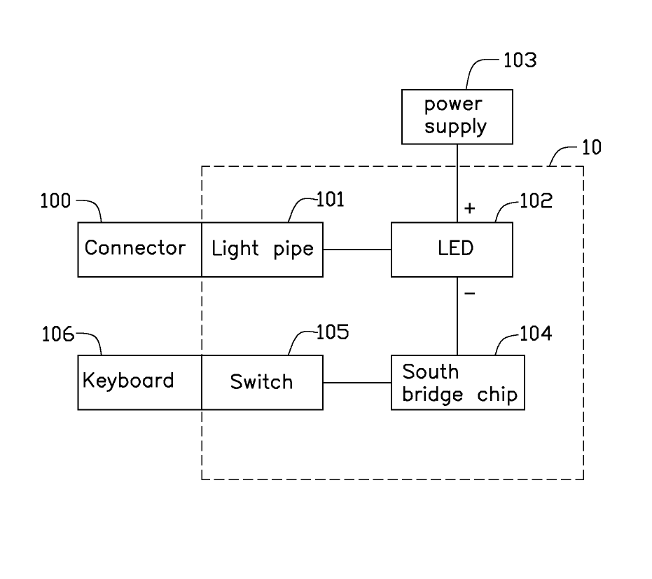

### BACKGROUND

1. Technical Field

The present disclosure relates to a device for lighting a position of a connector.

2. Description of Related Art

Computer connectors, such as universal serial bus (USB) connectors, are used to connect devices to transmit data. Typically the connectors are located in a rear chassis of an electronic device. It is difficult for users to see a location of a connector to use among all of the connectors in a dark environment.

Therefore, there is room for improvement in the art.

### BRIEF DESCRIPTION OF THE DRAWING

Many aspects of the present disclosure can be better understood with reference to the following drawing(s). The components in the drawing(s) are not necessarily drawn to scale, the emphasis instead being placed upon clearly illustrating the principles of the present disclosure. Moreover, in the drawing(s), like reference numerals designate corresponding parts throughout the several views.

The FIGURE is a block diagram of an embodiment of a connector position device of the present disclosure.

### DETAILED DESCRIPTION

The FIGURE shows an embodiment of a connector position device 10 of the present disclosure.

The connector position device 10 is used to light a position of a connector 100 of an electronic device. The connector position device 10 includes a light pipe 101, a light emitting diode (LED) 102, and a switch 105.

The LED 102 is arranged on a motherboard. A first end of the light pipe 101 is fixed facing the LED 102. A second end of the light pipe 101 is fixed facing the connector 100. The light pipe 101 is used to transmit the light from the LED 102 to the second end to light the connector 100.

An anode of the LED 102 is connected to a power supply 103 of the motherboard. A cathode of the LED 102 is connected to a south bridge chip 104 of the motherboard to receive a low level signal such as logic 0. In other embodiments, the LED 102 can be fixed facing the connector 100 to light the connector 100 directly, thus the light pipe 101 can be omitted to save cost.

The switch 105 is fixed on a keyboard 106 to control the south bridge chip 104 to output a high or low level signal to the LED 102. In other embodiments, the switch 105 can be fixed on other places where convenient operation, to control the south bridge chip 104 to output a high or low level voltage signal (logic 1/0) to the LED 102 can be performed.

The power supply 103 supplies a positive voltage to the anode of the LED 102 constantly. The south bridge chip 104 outputs a low level signal to the cathode of the LED 102 when the switch 105 is turned on. The LED 102 is lit. The light pipe 101 transmits light from the LED 102 to the second end of the light pipe 101 to light the connector 100.

When the switch 105 is turned off, the south bridge chip 104 will output a high level signal such as logic 1 to the cathode of the LED 102. The LED 102 turns off

While the disclosure has been described by way of example and in terms of preferred embodiment, it is to be understood that the disclosure is not limited thereto. To the contrary, it is intended to cover various modifications and similar arrangements as would be apparent to those skilled in the art. Therefore, the range of the appended claims should be accorded the broadest interpretation so as to encompass all such modifications and similar arrangements.

What is claimed is:

1. A connector position device, comprising:
a light emitting diode (LED) fixed facing a connector of a motherboard, wherein an anode of the LED is connected to a power supply, and a cathode of the LED is connected to a south bridge chip;
a switch connected to the south bridge chip to control the south bridge chip to output a high level signal or a low level signal; and
a light pipe, wherein a first end of the light pipe faces the LED, a second end of the light pipe faces the connector, the light pipe transmits light from the LED to the second end to light the connector.

2. The connector position device of claim 1, wherein the switch is fixed on a keyboard.

3. The connector position device of claim 1, wherein when the switch is turned on, the south bridge chip outputs a low level signal to the cathode of the LED; when the switch is turned off, the south bridge chip outputs a high level signal to the cathode of the LED.
